(19) United States
(12) Patent Application Publication
(10) Pub. No.: US 2012/0297216 A1
(43) Pub. Date: Nov. 22, 2012

(54) DYNAMICALLY SELECTING ACTIVE POLLING OR TIMED WAITS

(75) Inventors: Bret Ronald Olszewski, Austin, TX (US); Kelvin Ho, Ontario (CA); Roy Robert Cecil, Dublin (IE)

(73) Assignee: INTERNATIONAL BUSINESS MACHINES CORPORATION, Armonk, NY (US)

(21) Appl. No.: 13/111,345

(22) Filed: May 19, 2011

(51) Int. Cl. G06F 1/32; G06F 1/26

(52) U.S. Cl. 713/320; 713/300

(57) ABSTRACT

Dynamically selecting active polling or timed waits by a server in a clustered system includes determining a load ratio of a processor of the server, which is determined by calculating a ratio of an instantaneous run queue occupancy to a number of cores of the processor. The processor is occupied by a first runnable thread that requires a message response. A determination may be made whether power management is enabled on the processor, an instantaneous state may be determined based on the load ratio and whether power management is enabled on the processor, and a state process corresponding to the instantaneous state may be executed.

### BACKGROUND

The present invention relates to optimizing power usage and/or a measure of system performance (e.g., throughput) while maintaining data coherency, and more specifically, to an operating load of components involved in a clustered system having multiple thread processing capability.

In a clustered application like a database management system with a shared data architecture, the individual nodes of the database have to send messages to each other to maintain shared data structures in a coherent state. This messaging introduces latencies and creates wait queues which, if not managed well, may introduce degradation in the overall system throughput, waste processing cycles of the nodes, and increase power consumption. Systems that have predetermined values of timed waits, polling and processor yields may cause degradation of system throughput if the system is operated under a load profile for which the load profile configuration does not apply. Production systems having dynamic load profiles may yield poor or negative throughput when using such a predetermined, hard configuration.

Operating systems provide facilities for applications to determine a load profile from within software using an application programming interface (API). A query or function call to standard API's may be resource intensive, and sometimes involves systems calls that perform computation to arrive at a returned value. Some queries or functions calls to standard API's may involve burdensome averaging over long periods of times and may be counter-beneficial and cause further performance degradation for optimization purposes.

Computing systems provide power management facilities that may allow aspects of the system, including a processing unit or processor, to be throttled to optimize power consumption. Throttling may require the hardware to operate within a power or thermal envelop, whereby the system may adjust its processing characteristics and performance to operate within the prescribed envelope. Computing systems are capable of disabling portions of its processor or reducing the effective speed of the processor or portions thereof when the system is essentially idle.

### SUMMARY

According to one exemplary embodiment of the present invention, a method is provided for dynamically selecting active polling or timed waits by a server in a clustered database, the server comprising a processor and a run queue having at least a first runnable thread that occupies the processor and requires a message response, by determining a load ratio of the processor as a ratio of an instantaneous run queue occupancy to a number of cores of the processor, determining whether power management is enabled on the processor, determining an instantaneous state of the processor, wherein the instantaneous state is determined based on the load ratio of the processor and whether power management is enabled on the processor and executing, a state process, wherein the state process corresponds to the determined instantaneous state, wherein the first runnable thread occupies the processor and requires a message response.

According to another exemplary embodiment of the present invention, a server is provided for dynamically selecting active polling or timed waits, the server comprising a processor, the processor having a plurality of hardware threads, a network interface, a memory in communication with the network interface and the processor, the memory comprising a run queue, wherein the run queue has a first runnable thread that occupies the processor and requires a message response, the memory being operable to direct the processor to: determine a load ratio of the processor, the load ratio being calculated as a ratio of an instantaneous run queue occupancy to a number of cores of the processor, determine whether power management is enabled for the processor, determine an instantaneous state of the processor, and execute a state process, wherein the state process corresponds to the determined instantaneous state.

According to another exemplary embodiment of the present invention, a computer program product is provided for dynamically selecting active polling or timed waits by a server in a clustered database, the computer program product comprising a computer readable storage medium having computer readable program code embodied therewith, the computer readable program code comprising computer readable program code configured to instruct a database management system to: determine a load ratio of a processor, wherein the processor is occupied by a first runnable thread that requires a message response, and wherein the load ratio is calculated as a ratio of an instantaneous run queue occupancy to a number of cores of the processor; determine a power management state of the processor; determine an instantaneous state of the processor; and execute a state process, wherein the state process corresponds to the determined instantaneous state.

These and other features, aspects and advantages of the present invention will become better understood with reference to the following drawings, description and claims.

### BRIEF DESCRIPTION OF THE SEVERAL VIEWS OF THE DRAWINGS

FIG. 1 is a diagrammatic view of a clustered database system according to an exemplary embodiment of the present invention;

FIG. 2 is a diagrammatic view of a server in the clustered database system of FIG. 1;

FIG. 3 is a diagrammatic view of a server according to another embodiment of the present invention;

FIG. 4 is a flowchart of a method according to an exemplary embodiment of the present invention;

FIG. 5 is a flowchart of an aspect of the method of FIG. 4;

FIG. 6 is a flowchart of an aspect of the method of FIG. 4;

FIG. 7 is a flowchart of an aspect of the method of FIG. 4;

FIG. 8 is a flowchart of an aspect of the method of FIG. 4;

FIG. 9 is a flowchart of an aspect of the method of FIG. 8;

FIG. 10 is a flowchart of an aspect of the method of FIG. 7; and

FIG. 11 is a flowchart of an aspect of the method of FIG. 7.

### DETAILED DESCRIPTION

The following detailed description is of the best currently contemplated modes of carrying out exemplary embodiments of the invention. The description is not to be taken in a limiting sense, as the scope of the invention is defined by the appended claims.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server or as part of the monitor code. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Broadly, embodiments of the present invention provide a method, apparatus, and computer program product for dynamically selecting active polling or timed waits by a server in a clustered database including, for example, determining an instantaneous run queue occupancy, determining a number of cores of a processor, determining a load ratio of the processor by calculating a ratio of the instantaneous run queue occupancy to the number of cores, determining whether power management is enabled on the processor, determining an instantaneous state of the processor, and executing a state process, wherein the state process corresponds to the determined instantaneous state.

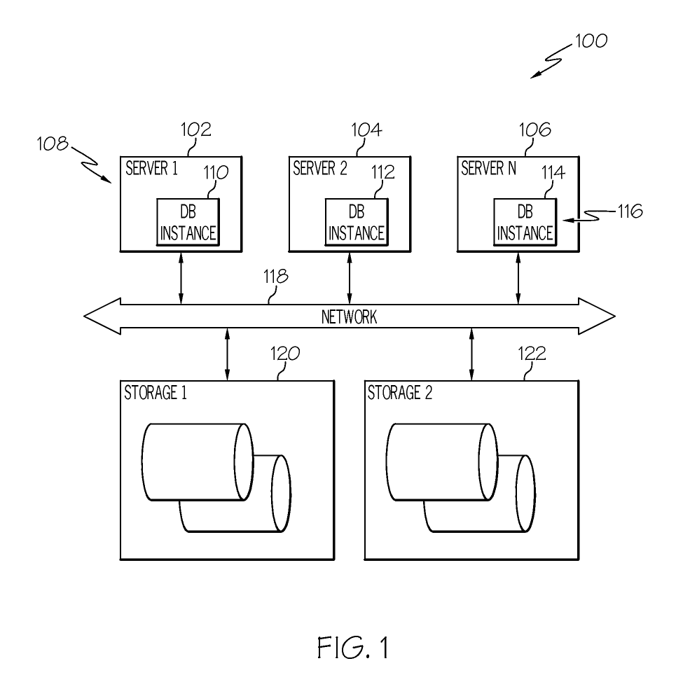

Embodiments of the present invention may be implemented in systems that include a distributed application or a clustered solution such as in a database management system, for example. With reference now to FIG. 1 a diagrammatic view of a clustered database system 100 is shown according to an exemplary embodiment of the present invention. System 100 may include a plurality of servers, the plurality of servers represented as server 1, 102, server 2, 104, through server N, 106, and collectively referenced as servers 108. Servers 108 may be computing devices configured to operate applications that may include a database (DB) instance, 110, database instance, 112, through database instance, 114, and collectively referenced as applications 116. According to some exemplary embodiments, servers 102, 104, and 106 may operate a plurality of logically independent databases instances thereon. Servers 108 may be interconnected by a network 118, which may provide communication there between. A plurality of storage devices including a storage 1, 120 and a storage 2, 122 may be interconnected to network 118. Servers 108 may operate applications 116 providing a service and executing transactions as a collective unit, or individually, in a high-availability configuration, for example.

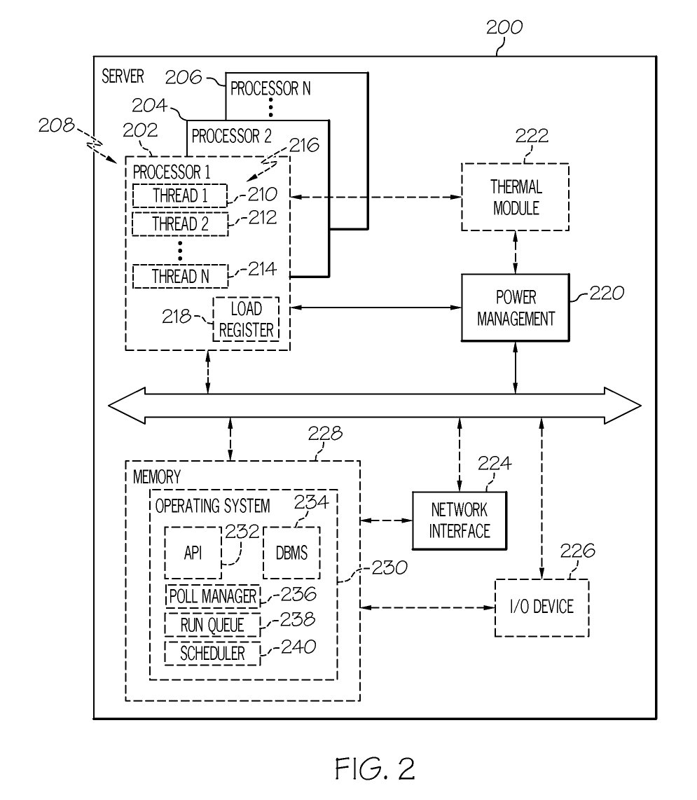

Referring now to FIG. 2 with concurrent references to elements in FIG. 1, a diagrammatic view of a server 200 of system 100 is shown, which may be representative of servers 108, for example. Server 200 may have a plurality of processors represented as processor 1, 202, processor 2, 204, through processor N, 206, and collectively referenced as processors 208. Processors 208 may have a number of cores (e.g., a core length or a hardware thread count), which may directly relate to a number of hardware threads available thereon. Processors 208 may be capable of running a plurality of threads represented as thread 1, 210, thread 2, 212, through thread N, 214, and collectively referenced as threads 216. Threads 216 may refer to a hardware thread or a logical thread, and may be capable of executing a program instruction. The hardware threads may be physically distinct and capable of executing program instructions simultaneously or independently. The logical threads may be a single hardware thread that may alternate between the logical threads using time-division multiplexing, for example. Processor 202 may have a load register 218, which may be capable of storing a value that may be read by threads 216 and updated by an operating system 230 or by other elements of server 200, for example. Processors 208 may be in communication with a power management module 220 and a thermal module 222. Power management module 220 may manage a power consumption of processors 208, which may be related to an operation being performed thereby or an operating speed thereof. Thermal module 222 may monitor or manage a thermal characteristic of processors 208, and may include monitoring a temperature thereof and operating a cooling device therefor.

A network interface 224 may provide communication between server 200 and, for example, a network 118. Network interface 224 may include a network interface card that may utilize Ethernet transport as well as emerging messaging protocols and transport mechanisms or communications links including Infiniband, for example. An input/output (I/O) device 226 may interface with a user, with computer readable media, or with external devices (e.g., peripherals) including, for example, a keyboard, a mouse, a touchpad, a track point, a trackball, a joystick, a keypad, a stylus, a floppy disk drive, an optical disk drive, or a removable storage device. I/O device 226 may be capable of receiving and reading non-transitory storage media. Server 200 may have a memory 228, which may represent random access memory devices comprising, for example, the main memory storage of server 200 as well as supplemental levels of memory (e.g., cache memories, nonvolatile memories, read-only memories, programmable or flash memories, or backup memories). Memory 228 may include memory storage physically located in server 200 including, for example, cache memory in processors 208, storage used as virtual memory, magnetic storage, optical storage, solid state storage, or removable storage.

Server 200 may have an operating system (OS) 230 loaded into memory 228 that may provide a basis for which a user or an application may interact with aspects of server 200. OS 230 may have an application programming interface (API) 232 that may facilitate an interaction between an application and OS 230 or other aspects of server 200. A database management system (DBMS) 234 may reside in memory 228 and may utilize API 232 to interact with aspects of serve 200. DBMS 234 may have a plurality of subsystems including, for example, a data definition subsystem, data manipulation subsystem, application generation subsystem, and data administration subsystem. DBMS 234 may maintain a data dictionary, file structure and integrity, information, an application interface, a transaction interface, backup management, recovery management, query optimization, concurrency control, and change management services. DBMS 234 may process logical requests, translate logical requests into physical equivalents, access physical data and respective data dictionaries. DBMS 234 may manage a database instance that may require communication with other database instances when operating in a clustered or distributed environment to maintain data coherency. Maintaining data coherency may require passing messages among the database instances, which may require transmitting messages and receiving messages. Communication among servers 108, for example server 200, in a clustered system may include remote direct memory access (RDMA), which may be used by servers 108 to directly communicate with a memory 228 of another server. RDMA communications may involve sending a message from a first server to a second server, and receiving a message response, by the first server, from the second server. According to certain application configurations (e.g., a clustered or distributed computing configuration), the message and the message response may be related or may have dependencies there betweeen (e.g., applications 116 operated by servers 108 may be synchronous), and therefore, a waiting period may be required before server 200 may continue processing a process or runnable thread. RDMA messaging requests may require a low latency to be computationally efficient, and thus, excessive waiting may be costly or detrimental to performance or power consumption.

A poll manager 236 may be configured to manage an interaction between processes (e.g., aspects of applications including DBMS 234) and regions or segments of memory 228, which may include, for example, message queues. Poll manager 236 may include scheduling semantics provided by operating system 230 (e.g., API 232), or any form of polling provided by DBMS 234 or the underlying server 200 architecture. A run queue 238 may logically manage any number of instructions or sets of instructions (hereinafter referred to as runnable threads) in memory 228 that may be waiting to be processed by threads 216. Run queue 238 may organize a plurality of runnable processes or instructions, (also referred to herein below as runnable threads) in a logical array that may have an occupancy measured as a length, size, or index that may indicate a number of runnable threads waiting to be processed. Run queue 238 may organize a list of software threads that may be in a ready state waiting for a hardware thread to become available. The length of run queue 238 may be a meaningful measure of a load on server 200. Run queue 238 may also include an empty run queue 238, having a zero length or size, for example. A scheduler 240 may determine which process from run queue 238 to execute next. According to some embodiments of the present invention, each core of processors 208 may have an associated run queue 238.

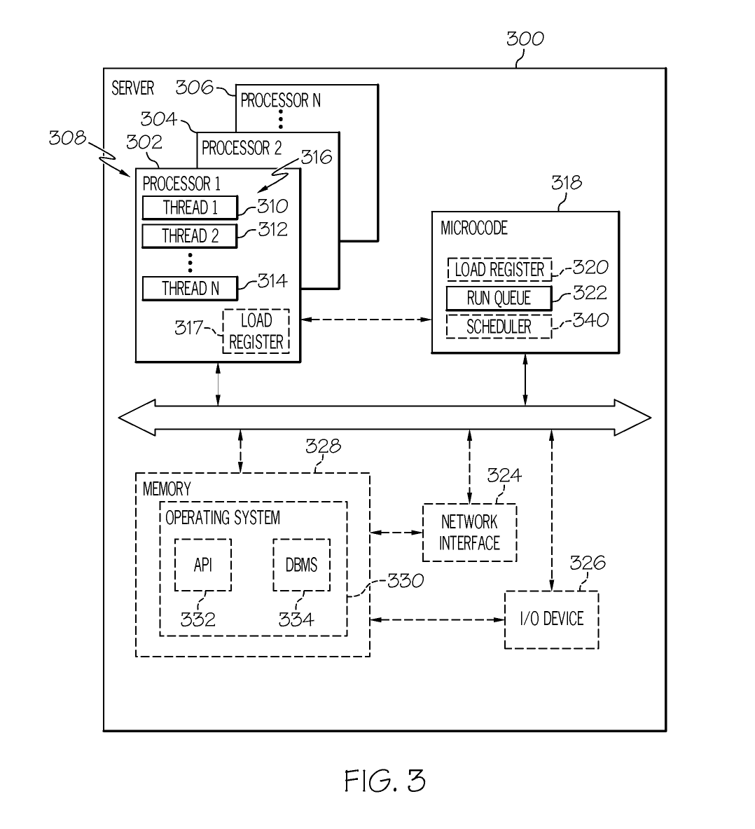

Referring now to FIG. 3, a diagrammatic view of a server 300 is shown according to another exemplary embodiment of the present invention. Server 300 may have a plurality of processors 308 comprising processor 1, 302, processor 2, 304, through processor N, 306, which may have a load register 317 and may be capable of running a plurality of threads 316 comprising thread 1, 310, thread 2, 312, through thread N, 314. Server 300 may have a microcode module 318, which may be a specifically designed set of instructions stored in memory 328 for implementing higher level machine language on server 300. Microcode module 318 may be stored in a read only memory (ROM), or in a programmable logic array (PLA) and may include, for example, firmware. Microcode 318 may implement a load register 320, a run queue 322, and a scheduler 340 therein. Server 300 may have a memory 328, which may have an operating system 330 loaded therein. Operating system 330 may have an application programming interface 332 and a database management system 334 residing therein. A network interface 324 and an input/output device 326 may provide communication and interface functionality for server 300.

It should be appreciated that system 100, server 200, and server 300 are intended to be exemplary and not intended to imply or assert any limitation with regard to the environment in which exemplary embodiments of the present invention may be implemented.

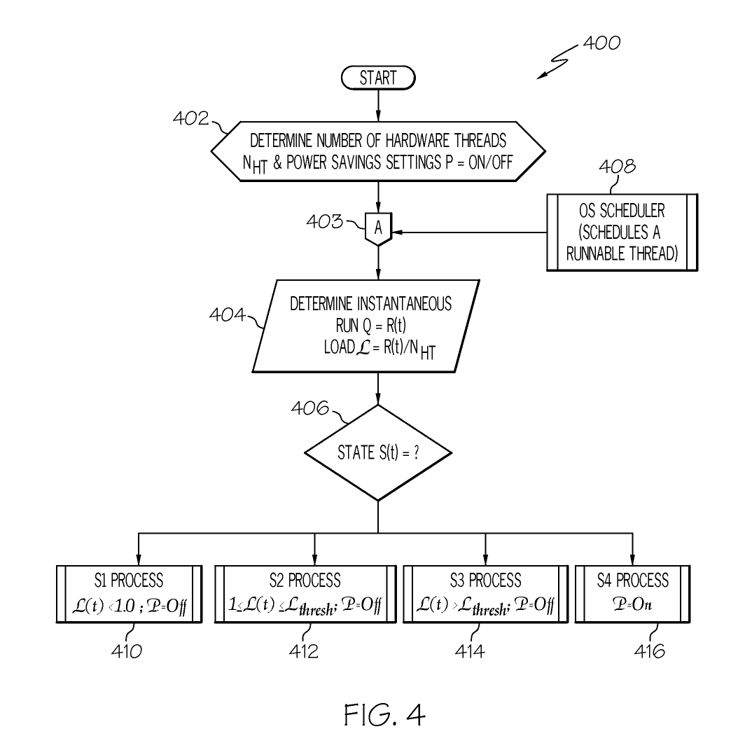

Referring now to FIG. 4 with concurrent references to elements in FIG. 2, a process flow diagram of a method 400 according to an exemplary embodiment of the present invention is shown. A number of hardware threads (e.g., N_{HT}) and power savings settings (e.g., Pₛ) may be determined (step 402). Reference A, 403, is shown here to illustrate the relationship between various aspects of exemplary embodiments described herein, and may have processes or steps that may merge thereto. Scheduler 240 may schedule or dispatch runnable threads to processors (henceforth implying any execution unit such as a core) 208 for execution (step 408). An instantaneous run queue depth (e.g., Run Q) and an instantaneous load (e.g., [symbol] ) may be determined (step 404). The instantaneous run queue depth may be determined as a length or index of run queue 238. The instantaneous load, [symbol] (interchangeably referenced as the load ratio) may be calculated as a ratio of the run queue depth to the number of hardware threads. A state of processors 208 (e.g., S(t)) may be determined (step 406), which may determine a load profile to execute. The determined state and corresponding load profiles may include a low processor utilization, an intermediate processor utilization, a high processor utilization, and a power savings state, for example. Based on the determined load profile, a corresponding process may be executed including a low processor utilization process 410, an intermediate processor utilization process 412, a high processor utilization process 414, and a power savings state process 416, denoted as processes S1. S2, S3, and S4, respectively. Low processor utilization (51) process 410 may be executed when instantaneous load [symbol] for a given time t, (e.g., [symbol] (t)), is below one, and power savings is turned off. Intermediate processor utilization (S2) process 412 may be executed when instantaneous load [symbol] for a given time t, ( [symbol] (t)), is greater than or equal to one and less than a threshold value (e.g., [symbol] ₜₕᵣₑₛₕ), and when power savings is turned off. High processor utilization (S3) process 414 may be executed when instantaneous load [symbol] for a given time t, ( [symbol] (t)), is greater than or equal to the threshold value, [symbol] ₜₕᵣₑₛₕ, and when power savings is turned off. A power savings state (S4) process 416 may be executed when power savings is active, or on, for the processors 208. The power savings state may be determined by querying power management 220. The threshold value, [symbol] ₜₕᵣₑₛₕ may be a value determined before runtime and determined by experimentation and/or by a fast method of observing variables like throughput over a period of time in real time. The threshold value, [symbol] ₜₕᵣₑₛₕ, may also be established by an application provider, and determined by the application characteristics and related the messages or transactions involved.

In some exemplary embodiments, runnable threads may be specifically allocated to an individual processor or set of processors of processors 208, which may have a respective poll manager 236, run queue 238, and scheduler 240 for implementing aspects of exemplary embodiments of the present invention.

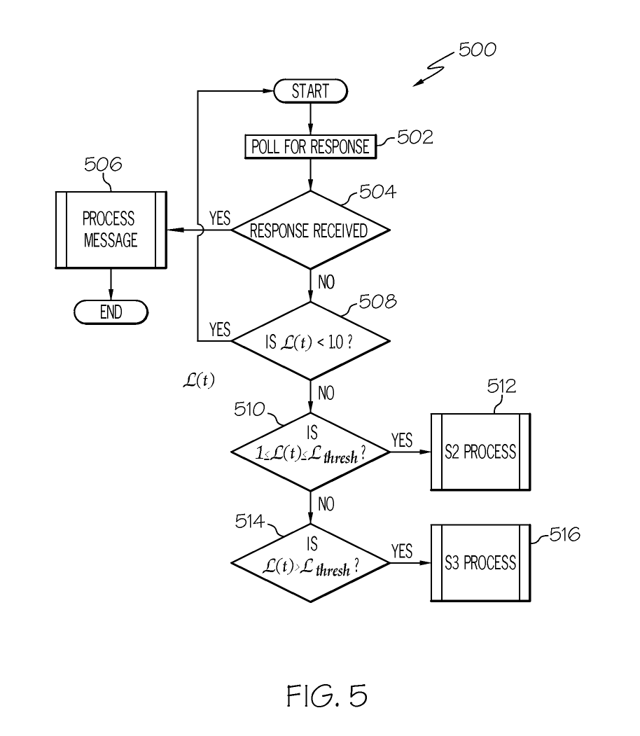

Referring now to FIG. 5 with concurrent references to elements in FIGS. 2 and 4, a flowchart 500 is shown that illustrates an exemplary embodiment of low processor utilization (S1) process 410 of FIG. 4. S1 process 410 may include polling, by poll manager 236, for a message response (step 502), from a server or an application (e.g., a database instance), that may be related to or in response to an initial message that may be sent by server 200 or by an application (e.g., DBMS 234). Poll manager 236 may determine whether the message response has been received (step 504), and processors 208 may process the message response (step 506) if the message response is determined to be received, otherwise an instantaneous load [symbol] for a given time t, ( [symbol] (t)) may be evaluated. If it is determined that [symbol] (t) is less than one (step 508), processing may restart at step 502. If it is determined that [symbol] (t) is greater than or equal to one and less than a threshold value [symbol] ₜₕᵣₑₛₕ (step 510), S2 process 412 may be executed (step 512). If it is determined that [symbol] (t) is greater than the threshold value [symbol] ₜₕᵣₑₛₕ (step 514), S3 process 414 may be executed (step 516).

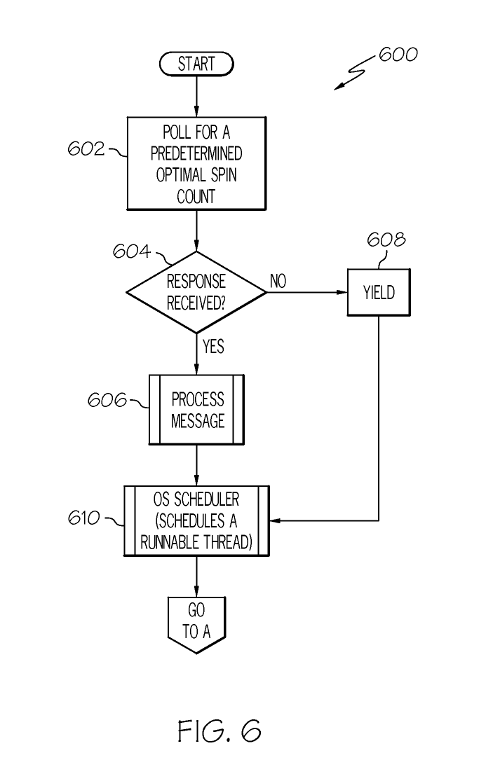

Referring now to FIG. 6 with concurrent references to elements in FIGS. 2 and 4, a flowchart 600 is shown that illustrates an exemplary embodiment of intermediate processor utilization (S2) process 412 of FIGS. 4 and 5. S2 process 412 may include polling for a predetermined spin count (step 602). The spin count may be a number of processor cycles consumed by poll manager 236 in polling, for example, a message queue, a file directory, or a memory address for a message. The spin count may be an optimal value that may be predetermined based on the expected message response, a priority of the message, and the initial message, or may be adaptively deduced based on statistics collected by an application, using API 232, for example, during the course of its operation, or knowledge gained based on load behavior known during the operation of the application in a given environment. Poll manager 236 may determine whether the message response has been received (step 604), and processors 208 may process the message response if it is received (step 606). If the message response has not been received, the scheduler 240 may yield (step 608), which may allow a second runnable thread to execute. The scheduler may subsequently schedule the second runnable thread from the run queue to process (step 610).

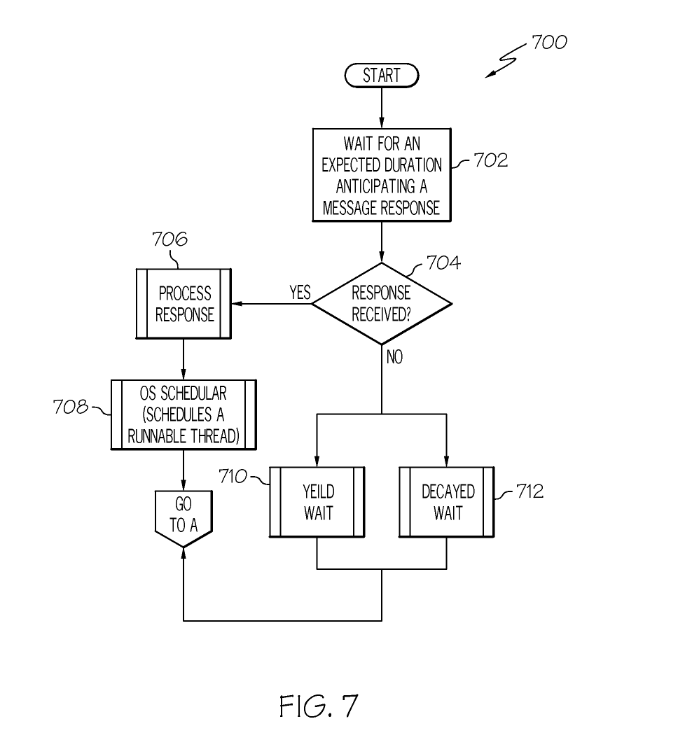

Referring now to FIG. 7 with concurrent references to elements in FIGS. 2 and 4, a flowchart 700 is shown that illustrates an exemplary embodiment of high processor utilization (S3) process 414 of FIGS. 4 and 5. S3 process 414 may include waiting, by poll manager 236, for a wait time anticipating a message response (step 702). The wait time may be an expected duration for the message response, and may be determined based on the message response expected, a priority of the message response, a priority of the initial message, and the initial message. During the wait time in step 702, processors 208 may undergo sleeping or idling, wherein a power consumption thereof may be reduced. Waiting, in step 702, may allow resources for other threads to be able to do useful work. Poll manager 236 may determine whether the message response has been received (step 704), and processors 208 may process the message response if it is determined to be received (step 706). Scheduler 240 may subsequently schedule a second runnable thread to process from run queue 238 (step 708). Scheduler 240 may continue processing at reference A, which may link to reference A, 403. If it is determined that the message response has not been received, scheduler 240 may call one of a yield wait process (step 710) or a decayed wait process (step 712). Upon completion of the yield wait process 710 or the decayed wait process 712, scheduler 240 may continue processing at reference A, which may link to reference A, 403.

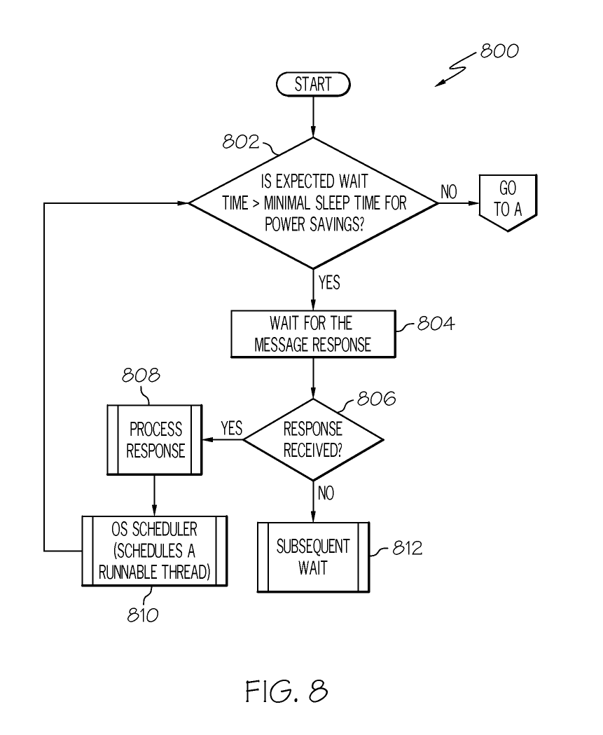

Referring now to FIG. 8 with concurrent references to elements in FIGS. 1, 2, and 4, a flowchart 800 is shown that illustrates an exemplary embodiment of power savings state (S4) process 416 of FIG. 4. S4 process 416 may include determining whether an expected wait time is greater than a minimum sleep time (step 802). The expected wait time may be a predetermined value based, for example, on a user preference, a message type, an operating platform, and server 200 or network 118 characteristics or may be determined dynamically based on statistics collected by an application, using API 232, for example, during the course of its operation, or knowledge gained based on load behavior known during the operation of the application in a given environment. The minimum sleep time may be a length of time or number of processor cycles below which a performance cost of performing a sleep or a wait may be greater than a benefit thereof, and may be referred to herein as a minimum useful sleep time. If the expected wait time is not greater than the minimum sleep time, scheduler 240 may continue processing at reference A, which may link to reference A, 403. If the expected wait time is greater than the minimum sleep time, scheduler 240 may wait for the message response (step 804). Waiting, in step 804, may allow resources for other threads to be able to do useful work. Poll manager 236 may determine whether the message response has been received (step 806), and processors 208 may process the message response if it is received (step 808). Scheduler 240 may subsequently schedule a second runnable thread to process from run queue 238 (step 810). In response to scheduler 240 subsequently scheduling a second runnable thread, scheduler 240 may continue processing at determining step 802. If it is determined in step 806 that the message response has not been received, scheduler 240 may call a subsequent wait process (step 812).

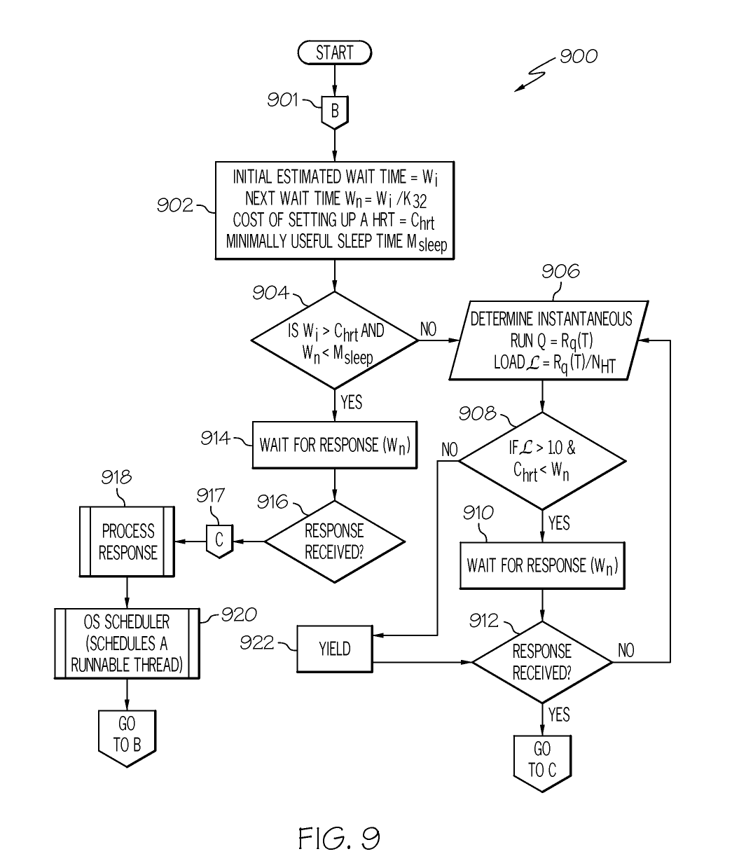

Referring now to FIG. 9 with concurrent references to elements in FIGS. 1 and 2, a flowchart 900 is shown that illustrates an exemplary embodiment of subsequent wait (also referred to herein as next wait) process 812 of FIG. 8. Reference B, 901, is shown here to illustrate the relationship between various aspects of exemplary embodiments described herein, and may have processes or steps that may merge thereto. Subsequent wait process 812 may include determining an initial estimated wait time (e.g., Wᵢ), determining a next wait time (e.g., Wₙ), determining a cost of setting up a high resolution timer (e.g., Cₕᵣₜ), and determining a minimum useful sleep time (e.g., Mₛₗₑₑₚ), by poll manager 236 (step 902). The initial estimated wait time, Wᵢ, may be a predetermined value based, for example, on a user preference, the message type, an operating platform, and server 200 or network 118 characteristics (e.g., the expected wait time), or based on actual prior wait times. The next wait time, Wₙ, may be determined as a calculation of the initial wait time divided by a computationally efficient value or factor, which may be a power of 2 (e.g., 32). The computationally efficient value may be a predetermined value that may be set based, for example, on a user preference, the message type, the operating platform, server 200, network 118 characteristics, or historical performance (e.g., previous historically successful values). The cost of setting up a high resolution timer, Cₕᵣₜ, may be a measurement or an estimate of the time or processor cycles needed for processors 208 to wait or sleep for the calculated next wait time, Wₙ. The minimum useful sleep time, Mₛₗₑₑₚ, may be a measurement of an estimate of the time or processor cycles below which it may not be computationally efficient for processors 208 to enter a sleep, or power savings, state due to the computational or processor overhead needed to enter the sleep, or power savings, state. A determination may be made whether the next wait time, Wₙ, is greater than the cost of setting up a high resolution timer, Cₕᵣₜ, and whether the next wait time, Wₙ, is greater than the minimum sleep time, Mₛₗₑₑₚ (step 904). If both step 904 conditions are met, scheduler 240 may wait for the message response for the next wait time, Wₙ, (step 914). A determination may be made whether the message response is received (step 916). Reference C, 917, is shown here to illustrate the relationship between various aspects of exemplary embodiments described herein, and may have processes or steps that may merge thereto. If the message response is received, the message response may be processed by processors 208 (step 918). Scheduler 240 may subsequently schedule a second runnable thread from run queue 238 to process (step 920). Scheduler 240 may continue processing at reference B, which may link to reference B, 901. If either of the step 904 conditions is false, an instantaneous run queue depth may be determined and an instantaneous load ratio [symbol] (t) may be calculated therewith as a ratio of the run queue depth to the number of hardware threads, N_{HT} (step 906). A determination may be made whether load ratio [symbol] (t) is greater than one and whether the next wait time Wₙ, is greater than the cost of setting up a high resolution timer Cₕᵣₜ (step 908). If either of the step 908 conditions is false, scheduler 240 may perform a yield action (step 922), whereby scheduler 240 may yield processing of the current runnable thread to a second runnable thread, which may allow the second runnable thread to execute or complete ahead of the current runnable thread. As used herein, a yield action, or yielding, may include communicating with scheduler 240 to obtain a second runnable thread, and setting aside a current thread to allow processing of the second runnable thread. Upon completion of processing of the second runnable thread, processing of the current runnable thread may resume, and a determination may be made whether the message response was received (step 912). If both conditions of step 908 are true, scheduler 240 may wait for a message response for the next wait time Wᵢ, (step 910). A determination may be made whether the message response is received (step 912). Processing may return to step 906 if the message response is not received or may otherwise processing may continue to reference C, which may link to reference C, 917, when the message response is received.

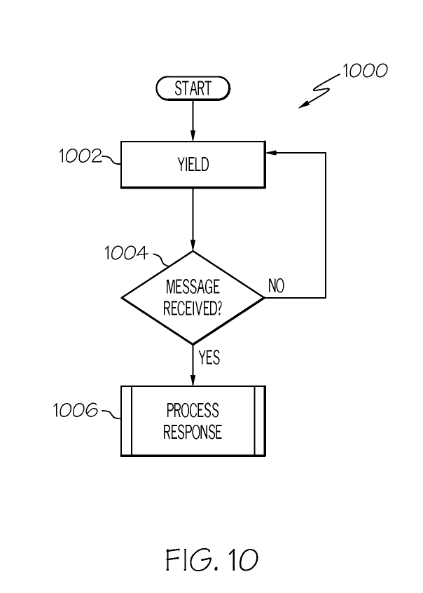

Referring now to FIG. 10, a flowchart 1000 is shown that illustrates an exemplary embodiment of yield wait process 710 of FIG. 7. Yield wait process 710 may include a yield action (step 1002), whereby scheduler 240 may yield processing of the current runnable thread to a second runnable thread. When processing returns to the first thread (e.g., the second runnable thread completes), the scheduler may determine whether the message response is received (step 1004) and may process the message response (step 1008) if the message response is received, or may otherwise return to the yield action (step 1002).

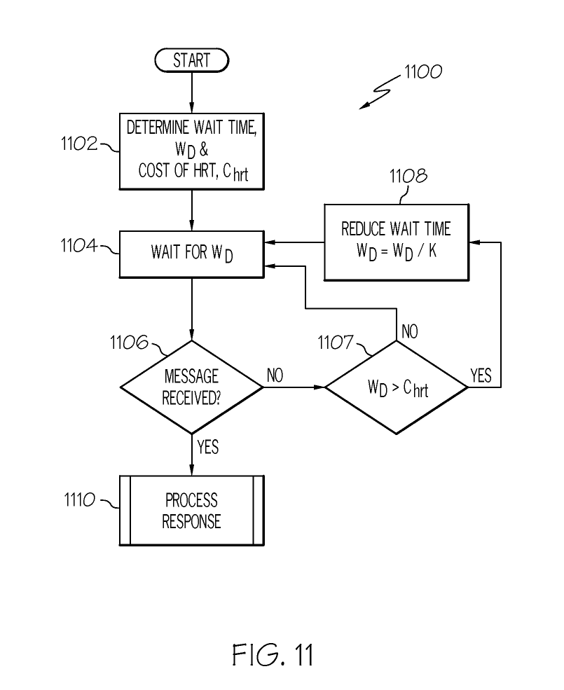

Referring now to FIG. 11 with concurrent references to elements in FIG. 2, a flowchart 1100 is shown that illustrates an exemplary embodiment of decayed wait process 712 of FIG. 7. Decayed wait process 712 may include a determination of a wait time, W_{D} and a cost of setting up a high resolution timer, Cₕᵣₜ (step 1102). The wait time, W_{D}, may be a predetermined minimum wait time, or may be determined based, for example, on a user preference, the message type, the operating platform, server 200, network 118 characteristics, or historical performance. Scheduler 240 may wait for the wait time, W_{D} (step 1104). Poll manager 236 may determine whether a message response was received (step 1106), and correspondingly process the message response if it is received (step 1110). If a message response is not received, scheduler 240 may determine whether the wait time, W_{D} is greater than the cost of setting up a high resolution timer, Cₕᵣₜ (step 1107) and reduce the wait time, W_{D}, by a computationally efficient value or factor, K (step 1108). The computationally efficient value or factor, K, may be a power of 2 (e.g., 32), and may be a predetermined value that may be based, for example, on a user preference, the message type, the operating platform, the server 200, network 118 characteristics or historical performance.

According to another exemplary embodiment of the present invention, a load register 218 may be used to track a run queue 238 occupancy or depth. Load register 218 may be read and modified by scheduler 240 in exemplary embodiments of the present invention. Scheduler 240 may increment load register when a process becomes runnable (i.e., a runnable thread), and decrement load register 218 when a runnable thread is scheduled on processors 208, thereby reducing the cost of determining the instantaneous run queue occupancy.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, ^{an} _{and} ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for dynamically selecting active polling or timed waits by a server in a clustered database, the server comprising a processor and a run queue having at least a first runnable thread that occupies the processor and requires a message response, the method comprising:
determining a load ratio of the processor as a ratio of an instantaneous run queue occupancy to a number of cores of the processor;
determining whether power management is enabled on the processor;
determining an instantaneous state of the processor, wherein the instantaneous state is determined based on the load ratio of the processor and whether power management is enabled on the processor; and
executing, a state process, wherein the state process corresponds to the determined instantaneous state, wherein the first runnable thread occupies the processor and requires a message response.

2. The method of claim 1 wherein the state process corresponding to a low processor utilization state comprises:
polling for the message response; and
determining whether the message response is received.

3. The method of claim 1, wherein the state process corresponding to an intermediate processor utilization state comprises:
polling for the message response; and
yielding the processor to a second runnable thread, in response to not receiving the message response.

4. The method of claim 1, wherein the state process corresponding to a high processor utilization state comprises:
reducing power consumption of the processor, for a predetermined duration;
polling for the message response, in response to reducing power consumption of the processor for the predetermined duration; and
performing one of a yield wait process and a decayed wait process, in response to not receiving the message response.

5. The method of claim 4, wherein:
the yield wait process comprises:
yielding the processor to a second runnable thread;
determining, in response to yielding the processor, whether the message response is received for the first runnable thread; and
processing the message response; and
the decayed wait process comprises:
determining a wait time;
waiting for the determined wait time;
determining whether the message response is received, in response to waiting; and
reducing the wait time by a predetermined factor, in response to determining the message response is not received.

6. The method of claim 1, wherein the state process corresponding to a power saving state comprises:
determining whether an expected wait time is greater than a minimal sleep time;
waiting for the message response;
determining whether the message response is received; and
performing a next wait process, in response to determining the message response is not received, wherein the next wait process comprises:
determining an estimated initial wait time;
determining a next wait time, wherein the determining the next wait time includes calculating a ratio of the initial wait time to a predetermined factor;
determining a cost of creating a high resolution timer;
determining a minimum sleep time;
waiting for the message response for the determined next wait time;
determining whether the determined load ratio is greater than one and whether the determined next wait time is greater than the cost of setting up a high resolution timer;
yielding the processor to a second runnable thread, in response to determining at least one of the calculated load ratio not being greater than one and the calculated next wait time not being greater than the cost of setting up a high resolution timer.

7. The method of claim 1, wherein the determining an instantaneous run queue occupancy includes reading a load register, the method further comprising:
scheduling the first runnable thread,
decrementing, by a scheduler, the load register, in response to scheduling the first runnable thread, wherein scheduling the first runnable thread comprises:
removing the first runnable thread from the run queue.

8. A server for dynamically selecting active polling or timed waits, the server comprising:
a processor, the processor having a plurality of threads;
a network interface;
a memory in communication with the network interface and the processor, the memory comprising a run queue, wherein the run queue has a first runnable thread that occupies the processor and requires a message response, the memory being operable to direct the processor to:
determine a load ratio of the processor, the load ratio being calculated as a ratio of an instantaneous run queue occupancy to a number of cores of the processor;
determine whether power management is enabled for the processor;
determine an instantaneous state of the processor; and
execute a state process, wherein the state process corresponds to the determined instantaneous state.

9. The server of claim 8, wherein the memory further comprises a load register; wherein the determining an instantaneous run queue occupancy includes reading the load register, wherein the calculating the load ratio uses a ratio of the instantaneous run queue occupancy to the number of cores, and wherein the memory is further operable to direct the processor to:
schedule the first runnable thread, and
decrement the load register in response to the first runnable thread being scheduled.

10. The server of claim 8, wherein the memory is further operable to direct the processor, in response to the processor being in a low processor utilization state, to:
poll for the message response; and
determine whether the message response is received.

11. The server of claim 8, wherein the memory is further operable to direct the processor, in response to the processor being in an intermediate processor utilization state, to:
poll for the message response;
yield the processor to a second runnable thread, in response to not receiving the message response.

12. The server of claim 8, wherein the memory is further operable to direct the processor, in response to the processor being in a high processor utilization state, to:
reduce a power consumption of the processor for a predetermined duration;
poll for the message response; and
perform one of a yield wait process and a decayed wait process.

13. The server of claim 8, wherein the memory is further operable to direct the processor, in response to the processor being in a power saving state, to:
determine whether an expected wait time is greater than a minimal sleep time;
wait for the message response;
determine whether the message response is received; and
perform a next wait process, in response to determining the message response is not received.

14. A computer program product for dynamically selecting active polling or timed waits by a server in a clustered database, the computer program product comprising:
a computer readable storage medium having computer readable program code embodied therewith, the computer readable program code comprising:
computer readable program code configured to instruct a database management system to:
determine a load ratio of a processor, wherein the processor is occupied by a first runnable thread that requires a message response, and wherein the load ratio is calculated as a ratio of an instantaneous run queue occupancy to a number of cores of the processor;
determine a power management state of the processor;
determine an instantaneous state of the processor; and
execute a state process, wherein the state process corresponds to the determined instantaneous state.

15. The computer program product of claim 14, wherein the computer readable program code is further configured to instruct the database management system to:
determine the instantaneous state of the processor as low processor utilization when power management of the processor is disabled and the load ratio is less than one;
determine the instantaneous state of the processor as intermediate processor utilization when power management of the processor is disabled, the load ratio is greater than one, and the load ratio is less than or equal to a threshold load ratio value;
determine the instantaneous state of the processor as high processor utilization when power management of the processor is disabled and the load ratio is greater than the threshold load ratio value; and
determine the instantaneous state of the processor as power savings when power management of the processor is enabled.

16. The computer program product of claim 14, the computer readable program code further configured to instruct the database management system, wherein the determined instantaneous state is a low processor utilization state, to:
poll for the message response; and
determine whether the message response is received.

17. The computer program product of claim 14, the computer readable program code further configured to instruct the database management system, wherein the determined instantaneous state is an intermediate processor utilization state, to:
poll for the message response; and
yield the processor to a second runnable thread, in response to not receiving the message response.

18. The computer program product of claim 14, the computer readable program code further configured to instruct the database management system, wherein the determined instantaneous state is a high processor utilization state, to:
reduce power consumption of the processor, for a predetermined duration;
poll for the message response, in response to reducing power consumption of the processor;
perform one of a yield wait process and a decayed wait process, in response to not receiving the message response.

19. The computer program product of claim 14, the computer readable program code further configured to instruct the database management system, wherein the determined instantaneous state is a power saving state, to:
determine whether an expected wait time is greater than a minimal sleep time;
wait for the message response;
determine whether the message response is received; and
perform a next wait process, in response to determining the message response is not received.

20. The computer program product of claim 14, the computer readable program code further configured to instruct the database management system to:
read a load register;
schedule the first runnable thread; and
decrement the load register in response to the first runnable thread being scheduled.
